(19) United States
(12) Patent Application Publication
(10) Pub. No.: US 2026/0063190 A1
(43) Pub. Date: Mar. 5, 2026

(54) ELECTRIC DRIVE SYSTEM

(71) Applicant: DANA ITALIA S.R.L., Arco, Trentino (IT)

(72) Inventors: Idris POONAWALA, Pune (IN); Sushil PATIL, Pune (IN); Pradip JASUD, Pune (IN); Paresh JOSHI, Pune (IN)

(21) Appl. No.: 18/822,992

(22) Filed: Sep. 3, 2024

(51) Int. Cl. F16H 37/08; B60K 1/00; B60K 17/04; B60K 17/16; B60L 50/60; B60T 1/06; F16H 63/34

(52) U.S. Cl. CPC F16H 37/082; B60K 1/00; B60K 17/046; B60K 17/165; B60L 50/60; B60T 1/062; F16H 37/0813; F16H 63/345; B60K 2001/001

(57) ABSTRACT

An electric drive system is herein provided. In one example, an electric drive system comprises an electric motor rotationally coupled to a high-speed reduction gear set (HSRU) and a parking brake assembly also coupled to the HSRU. The HSRU rotationally couples to a differential assembly via a pinion gear assembly including a pinion shaft and a bevel pinion gear pair.

### TECHNICAL FIELD

Embodiments of the subject matter disclosed herein relate to electric vehicles, and more specifically to electric vehicle transmission systems.

### BACKGROUND AND SUMMARY

Electric vehicles make use of electric drive units to generate motive power and provide an attractive alternative in terms of hydrocarbon emissions in relation to vehicles that solely rely on internal combustion engines for propulsion. Electric drive units often comprise transmissions that include a plurality of clutches, gears, and shafts to transfer mechanical power from one or more motors to downstream components such as drive shafts, drive axles, differentials, and the like. Improving efficiency and optimizing functionality of the drive unit design allows for better performance of vehicles, especially electric and hybrid vehicles, which employ electric drive units.

Traditional electric gearbox designs, combined with drive shafts, often require additional space for integrating the electric motor with the drive axle. Further, the presence of more driveline components in the electric drive unit, including the gearboxes, drive shafts, and drive axles, leads to higher mechanical efficiency losses. Traditionally, parking brakes are arranged within an electric driveline vertically. For example, a parking brake may be arranged between a transmission and a differential in a vertical orientation. As a result, additional space is required for the drive system.

The inventors herein have recognized the aforementioned issues and developed an electric drive system that at least partially addresses these issues. The electric drive unit, in one example, includes an electric motor configured to drive a high-speed reduction gearbox (HSRU) and a parking brake assembly. The parking brake assembly may be arranged horizontally with respect to the motor and HSRU. The electric motor is configured to propel the HSRU, which then transfers input power to the differential assembly via a pinion gear. The differential assembly couples to axle shafts configured to drive wheels. Specifically, a first axle shaft drives a first wheel hub and a second axle shaft drives a second wheel hub. These first and second wheel hubs couple to planetary gear assemblies which are configured to transfer power to the wheels.

As noted, the parking brake assembly may be horizontally mounted on the HSRU and may coexist with the motor. The parking brake is configured to hold the pinion gear via a brake disc, connected through a brake flange and an internal gear of the HSRU. In this way, with the parking brake mounted horizontally on the gear box, space usage may be optimized and overall footprint of the system may be reduced, thereby freeing up more space within the vehicle for other components.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an exemplary vehicle.

FIG. 2 shows a schematic of a vehicle system.

FIG. 3A shows a first example of a conventional drive system.

FIG. 3B shows a second example of a conventional drive system.

FIG. 4 shows a schematic diagram of an electric drive system.

FIG. 5 shows a perspective view of an electric drive system.

FIG. 6 shows a cross-sectional view of the electric drive system of FIG. 5.

FIG. 7 shows schematic diagrams of operational configurations of a parking brake assembly of the electric drive system of FIGS. 5 and 6.

### DETAILED DESCRIPTION

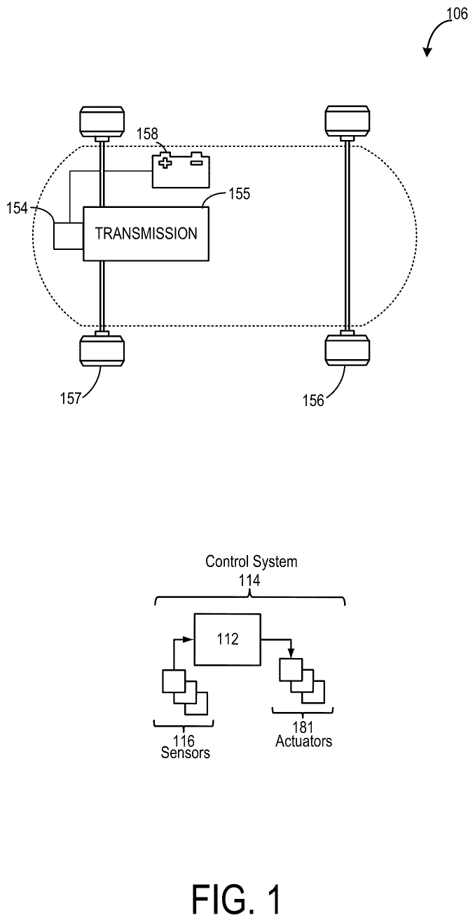

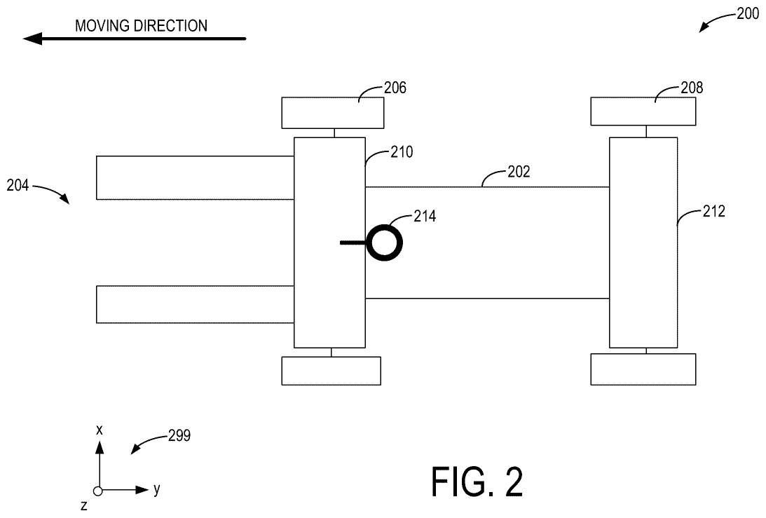

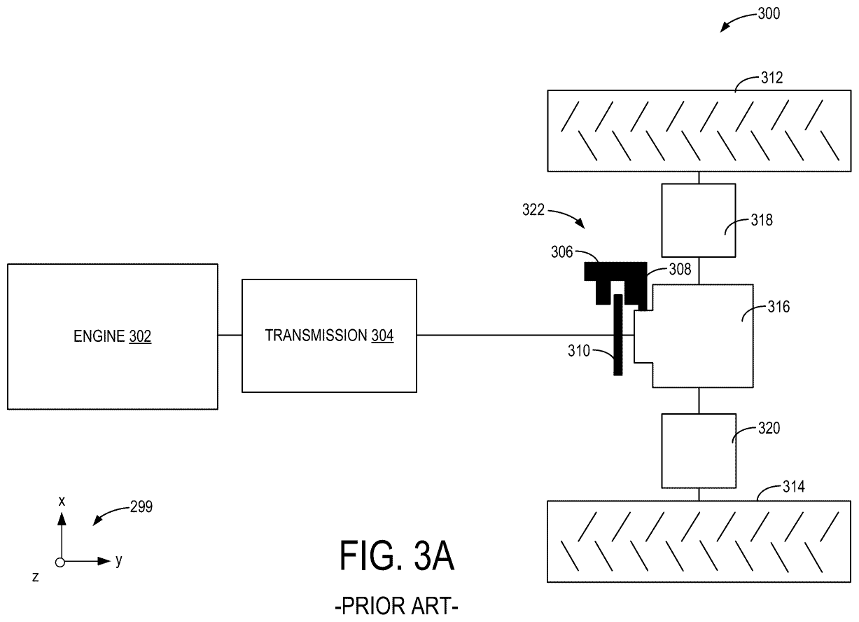

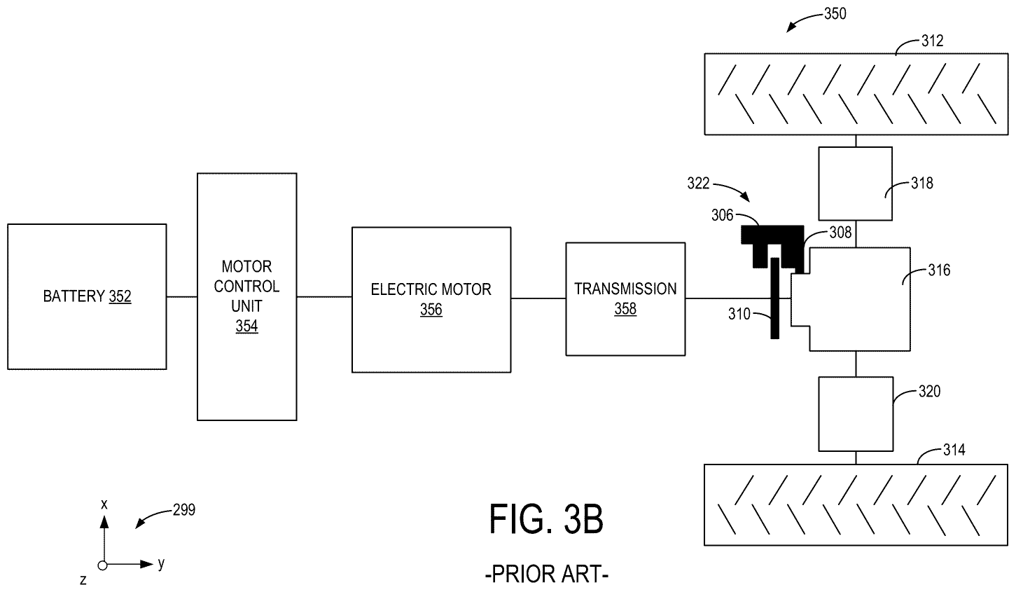

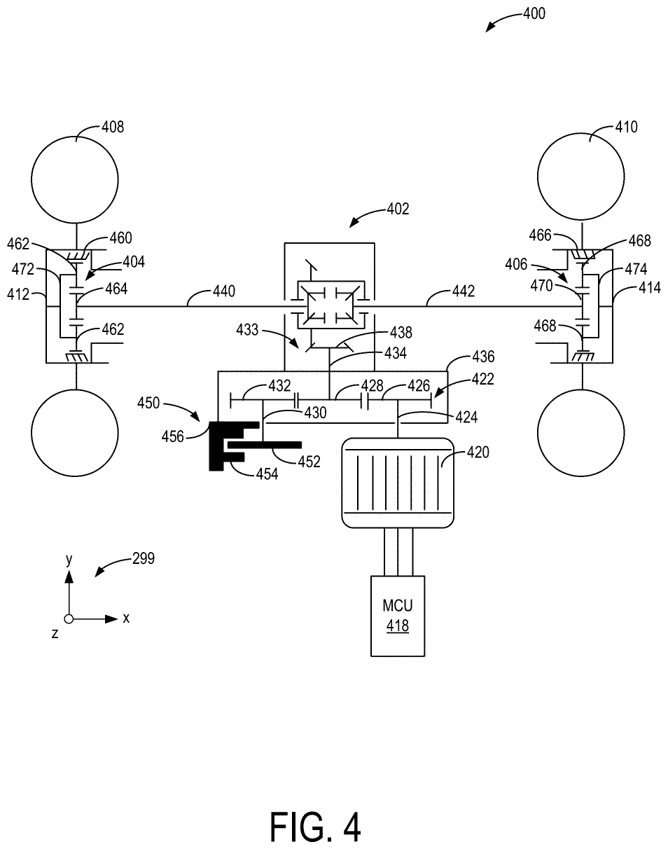

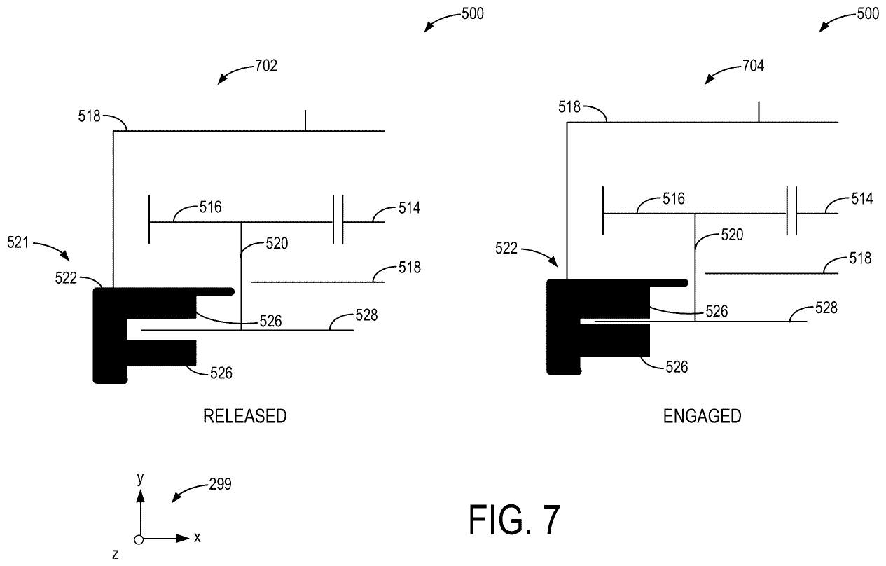

The following description relates to systems and methods for an electric drive system of an electric vehicle comprising an electric motor, a transmission system including a gear box, a parking brake, a differential, and wheel assemblies. The gear box may comprise a gear set therewithin, such as a high-speed reduction gear set (HSRU). The parking brake may be mounted horizontally on the HSRU. As will be herein described, the electric motor may provide power to the HSRU, which may provide power to downstream components. The downstream components include the differential and the wheel assemblies. Via respective axle shafts, the differential may transfer power to wheel hubs via planetary assemblies. With the parking brake assembled horizontally with the HSRU, the overall compactness of the drive system may be reduced. An exemplary electric vehicle is shown in FIG. 1 and an exemplary drive system of the electric vehicle is schematically depicted in FIG. 2. Examples of conventional drivetrains, for both internal combustion engine vehicles and electric vehicles, are provided in FIGS. 3A and 3B. Diagrams of the electric drive system herein presented are shown in FIGS. 4-6. Example configurations of a parking brake assembly of the electric drive system herein presented is shown in FIG. 7.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to the figures, FIG. 1 shows a schematic depiction of a vehicle system 106 that can derive propulsion power from one or more electric motors 154 (e.g., a drive motor). The vehicle system 106 is herein described as a forklift vehicle, however it should be understood that other vehicle systems are possible without departing from the scope of this disclosure. In one embodiment, electric motors 154 may be traction motors. Electric motors 154 receives electrical power from a traction battery 158 to provide torque to rear vehicle wheels 157 via transmission 155. Electric motors 154 may also be operated as a generator to provide electrical power to charge traction battery 158, for example, during a braking operation. It should be appreciated that while FIG. 1 depicts electric motors 154 and transmission system 155 mounted in a rear wheel drive configuration, other configurations are possible, such as employing the electric motor 154 in a front wheel configuration, or in a configuration in which a first output yoke or other interface drives the rear vehicle wheels 157 and a second output yoke or other interface drives front vehicle wheels 156.

Electric motors 154 and transmission 155 may be included as part of an electric drive unit (e.g., an electric drive system). In some examples, the electric motors 154 may be integrated with a gearbox of the transmission system 155. Additionally or alternatively, the electric motor 154 may be coupled to an outside of a transmission/gearbox housing. The transmission/gearbox may include at least one clutch and one or more shafts, as will be described below. Controller 112 may send a signal to an actuator of the clutch(es) to engage or disengage the clutch(es), so as to couple or decouple power transmission from the electric motor 154 to various shafts and gears therein.

Controller 112 may form a portion of a control system 114. Control system 114 is shown receiving information from a plurality of sensors 116 and sending control signals to a plurality of actuators 181. As one example, sensors 116 may include sensors such as a battery state of charge sensor, speed sensors, brake pedal sensors, etc. As another example, the actuators may include the clutch(es), friction plates, etc. The controller 112 may receive input data from the various sensors, process the input data, and trigger the actuators in response to the processed input data based on instruction or code programmed therein corresponding to one or more routines. As an example, operator input to a brake pedal may generate a signal for the brake pedal sensor, which may be transmitted to the controller 112. Based on the signal received at the controller 112, the controller 112 may trigger brake friction plates to halt rotation of the wheel hubs, thereby bringing the vehicle to a stop.

Turning now to FIG. 2, a schematic diagram of a vehicle system 200 is shown. In the example shown, the vehicle system 200 is a forklift, though it should be understood that the vehicle system 200 may take other configurations without departing from the scope of this disclosure. The vehicle system 200 may be an example of the vehicle system 106 described with respect to FIG. 1, in some examples. An axis system 299 is provided in FIG. 2, as well as FIGS. 3A-7, for reference. An x-axis may be a lateral axis, a y-axis may be a longitudinal axis, and a z-axis may be a vertical axis (e.g., parallel with a gravitational axis).

The vehicle system 200 may include a chassis 202 coupled to a front drive axle 210 and a rear drive steer axle 212. The front drive axle 210 may couple to front wheels 206 and the rear drive steer axle 212 may couple to rear wheels 208. As described above and will be further enumerated herein below, the front drive axle 210 and/or the rear steer axle 212 may be a portion of or otherwise coupled to a drive system (e.g., a drive unit or drivetrain) of the vehicle system 200, the drive system comprising an electric motor, a transmission system (e.g., one or more gear boxes), and a differential. In some examples, the drive system may be coupled to only one of the front drive axle or rear steer axle. For example, in front wheel drive configurations, the drive system may be coupled to the front drive axle and in rear wheel drive configurations, the drive system may be coupled to the rear steer axle. In some examples, a steering wheel 214 may also be included in the vehicle system 200. The steering wheel 214 may provide signals to a control system of the drive system to control wheel angle to steer the vehicle. In some vehicle cases, rear axle may be a drive axle and the front axle may be a steer axle. The parking brake arrangement as herein disclosed may be used for drive axles rather than steer axles, in some examples.

When the vehicle system 200 is a forklift, as shown in FIG. 2, the vehicle system 200 may further include forks 204. The forks 204 may be configured for materials to be positioned atop them, thereby allowing the vehicle to carry and transport the materials.

FIGS. 3A and 3B shows schematic diagrams of typical drive systems, as may be incorporated into a vehicle system, such as vehicle system 106 and/or vehicle system 200. Specifically, FIG. 3A shows a drive system 300 in an internal combustion engine vehicle and FIG. 3B shows a drive system 350 in an electric vehicle. Certain components are shared between the drive system 300 and the drive system 350 and thus will not be reintroduced, for brevity.

In the drive system 300, an engine 302 is coupled to a transmission 304. Power generated by the engine 302 is transmitted to the transmission 304 and from the transmission 304 to a differential 316. A parking brake assembly 322 may also be coupled to the differential 316. As shown, the parking brake assembly 322 may be arranged between the transmission 304 and the differential 316 along the longitudinal direction. The parking brake assembly 322 may include a parking brake 306, a parking brake bracket 308, and a parking brake disc 310. As an example, the parking brake bracket 308 may be mounted on a housing or case of the differential 316 and the parking brake disc 310 may be rotationally coupled to an output shaft of the transmission 304.

In the drive system 350, a battery 352 is coupled to a motor control unit (MCU) 354, which is coupled to an electric motor 356. The electric motor 356 receives electrical power from the battery 352 via the MCU 354. The electric motor 356 may be coupled to an electric transmission 358, which may include combinations of gears and clutches arranged in gear sets, in some examples. Power from the electric motor 356 may thus be transferred through the transmission 358 to the differential 316. Similar to the drive system 300, in the drive system 350, the parking brake assembly 322 may be coupled in an arrangement between the transmission 358 and the differential 316 along the longitudinal direction. For example, the parking brake bracket 308 may be mounted on a case of the differential 316 and the parking brake disc 310 may be rotationally coupled on an output shaft of the transmission 358. The longitudinal arrangement of the parking brake assembly between the transmission and the differential, in either internal combustion engine systems or electric systems, may increase space requirements of the drive system.

In both the drive system 300 and the drive system 350, the differential 316 may be coupled to final drives 318 and 320. The final drive 318 may be rotationally coupled to a first wheel 312 and the final drive 320 may be rotationally coupled to a second wheel 314. As an example, the first wheel 312 may be a right rear wheel and the second wheel 314 may be a left rear wheel. In another example, the first wheel 312 may be a left front wheel and the second wheel 314 may be a right front wheel, depending on the type of drive the vehicle system employs.

As noted, in the drive systems 300 and 350 presented herein, the parking brake assembly is arranged inline longitudinally between the transmission and the differential assembly. Engagement of the parking brake assembly, for example via frictional engagement of brake pads against a brake disc, may halt rotation of the components of the differential, and thus as a result halt any potential rotation of the wheels and axles. However, with the parking brake assembly arranged inline between the transmission and the differential assembly for example mounted on the output shaft of the transmission and to a case of the differential, space requirements of the drivetrain, especially in the longitudinal direction of the vehicle, may be increased.

Turning now to FIG. 4, a schematic diagram of an electric vehicle drive system 400 is shown. The electric vehicle drive system 400 may be incorporated into a vehicle system, such as vehicle system 106 depicted in FIG. 1 and/or the vehicle system 200 depicted in FIG. 2. The axis system 299 is again provided in FIG. 4. As noted, the x-axis may be a lateral axis, a y-axis may be a longitudinal axis, and a z-axis may be a vertical axis (e.g., parallel with a gravitational axis). In contrast to the drive system 300 of the vehicle with an internal combustion engine described above, electric drivetrains as herein proposed may allow for lower running costs due to reduced electricity expenses, lower maintenance demands of electric motors compared to internal combustion engines, increased energy efficiency, and decreased operation noise. Further, electric motors, as herein described, allow for delivery of maximum torque without the demand of a specific speed as is required in internal combustion engines.

The electric vehicle drive system 400 may comprise an MCU 418. The MCU 418 may be coupled to an electric motor 420. The MCU 418 may be configured to provide power to the electric motor 420 from one or more batteries, in some examples, by converting direct current (DC) to alternating current (AC) via an inverter. The MCU 418 may also be configured to control the vehicle's speed and acceleration based on various inputs (e.g., throttle inputs).

The electric motor 420 may be configured to receive power from the MCU 418 and transmit power to one or more transmission components. For example, the electric motor 420 may be configured to transmit power to an HSRU 422 via an input shaft 424 (e.g., a rotor shaft). The HSRU 422 may comprise a gear set (e.g., an input speed reduction gear set) including a first gear 426, a second gear 428, and a third gear 432. The first gear 426 may mesh with the second gear 428, the second gear may mesh with both the first gear 426 and the third gear 432, and the third gear may mesh with the second gear 428. Thus, the second gear 428 may be positioned between the first and third gears 426, 432 along a horizontal axis.

The input shaft 424 of the electric motor 420 may be rotationally coupled to the first gear 426, which as noted may mesh with the second gear 428. The second gear 428 may also rotationally couple a pinion assembly 433. The pinion assembly 433 may comprise a pinion shaft 434 and a bevel pinion gear pair 438. The pinion shaft 434 may be configured to transfer power to a differential assembly 402, for example via the bevel pinion gear pair 438 that is coupled to a gear of the differential assembly 402. The HSRU 422 may be encompassed within an HSRU housing 436, in some examples.

A parking brake assembly 450 may be coupled to the HSRU 422. The parking brake assembly 450 may comprise a brake disc 452, one or more brake pads 454, and a parking brake bracket 456. The brake disc may be coupled to a parking brake shaft 430. The parking brake assembly 450 may be coupled to the HSRU 422 in a horizontal arrangement. For example, the parking brake assembly 450 may be coupled to the third gear 432 of the HSRU 422 via the parking brake shaft 430, wherein the parking brake shaft 430 is rotationally coupled to the third gear 432 of the HSRU 422. In this way, the electric motor 420 and the parking brake assembly 450 may coexist in the sense that they are arranged horizontally with each other along the lateral axis. The parking brake assembly 450, via the brake disc 452, may hold the pinion shaft 434. The brake disc 452 may be connected through a brake flange and the third gear 432 of the HSRU 422.

The differential assembly 402 may couple to a first drive axle shaft 440 and a second drive axle shaft 442. As an example, the first drive axle shaft 440 may be a left axle shaft half and the second drive axle shaft 442 may be a right axle shaft half. Each of the first and second axle shafts 440, 442 may be configured to transfer rotational power to respective wheel hubs. For example, the first drive axle shaft 440 may couple to a first wheel hub 412 via a first planetary gear assembly 404 and the second drive axle shaft 442 may couple to a second wheel hub 414 via a second planetary gear assembly 406.

The first planetary gear assembly 404 may comprise a sun gear 464 coupled for rotation with the first drive axle shaft 440. A plurality of planet gears 462 are in meshed engagement with the sun gear 464 and are driven thereby. The planet gears 462 are also in meshed engagement with a source for ground, such as stationary housing 460. In some examples, the stationary housing 460 may comprise a locked planetary ring gear. Further, the planet gears 462 may be carried by a planet carrier 472 that is rotationally coupled to the first wheel hub 412.

Similarly, the second planetary gear assembly 406 may comprise a sun gear 470 coupled for rotation with the second drive axle shaft 442. A plurality of planet gears 468 are in meshed engagement with the sun gear 470 and are driven thereby. The planet gears 468 are also in meshed engagement with a source for ground, such as the stationary housing 466. In some examples, the stationary housing 466 may comprise a locked planetary ring gear. Also, in some examples, the stationary housing 460 and the stationary housing 466 may be portions of the same stationary housing. Further, the planet gears 468 may be carried by a planet carrier 474, which may be rotationally coupled to the second wheel hub 414.

The first wheel hub 412 may be rotationally coupled to first wheel 408 and the second wheel hub 414 may be rotationally coupled to second wheel 410. In some examples, the first wheel 408 may be a left wheel of a front wheel set and the second wheel 410 may be a right wheel of the front wheel set. In another example, the first wheel 408 may be a left wheel of a rear wheel set and the second wheel 410 may be a right wheel of the rear wheel set.

As opposed to traditional electric drive system arrangements, such as shown in FIG. 3B, which include a parking brake arranged inline between a transmission system (e.g., one or more gear boxes) and a differential along the longitudinal direction, the systems herein disclosed include a parking brake assembly arranged horizontally adjacent to the electric motor. Specifically, the parking brake assembly is mounted on the HSRU, coupled to the HSRU via a parking brake shaft. The parking brake assembly may coexist horizontally with the electric motor such that both the parking brake shaft and the input shaft of the electric motor couple to the HSRU on the same side. Thus, the parking brake assembly and the electric motor may be arranged alongside each other on the same side of the HSRU.

When the electric motor 420 is in operation, for example when the vehicle is in a drive mode, rotational power may be transferred from the electric motor 420, into the input shaft 424, and to the first gear 426. From the first gear 426, rotational power may be transferred into the second gear 428 with which the first gear 426 is meshed. From the second gear, rotational power may be transferred into the pinion assembly 433. In some examples, the pinion shaft of the pinion assembly 433 may thus function as an output shaft for the HSRU 422. From the pinion assembly 433, rotational power may be transferred into the differential assembly 402. From the differential assembly 402, torque may be transferred into the first and second axle shafts 440, 442. Torque may then be transferred from the first and second axle shafts 440, 442 into the first and second planetary assemblies 404, 406. Rotation of the first and second planetary assemblies 404, 406 may result in rotation of the first and second planet carriers 472, 474, which in turn may cause the first and second wheels 408, 410 to rotate, propelling the vehicle in a chosen direction (e.g., forward or backwards). Rotation of the second gear 428 may also transfer rotation to the third gear 432 and thus to the parking brake disc 452. With the parking brake pads 454 unengaged from the parking brake disc 452, the parking brake disc 452 may rotate freely.

As will be further described below, the parking brake assembly 450 may be engaged when the electric motor 420 is not providing power to the system. When the parking brake assembly 450 is engaged, via frictional engagement of the parking brake pads 454 with the parking brake disc 452, the parking brake disc 452 may not rotate. Without rotation available in the parking brake disc 452, downstream connected components may also not be allowed to rotate. For example, the third gear 432 may not rotate, which may not allow the second gear 428 to rotate. Thus the differential assembly 402, the first and second axle shafts 440, 442, first and second planetary assemblies 404, 406, and the first and second wheel hubs 412, 414 may not rotate. Without rotation available to the first and second wheel hubs 412, 414, the first and second wheels 408, 410 may not rotate due to external sources (e.g., rolling down a hill). Thus, the vehicle may remain at a standstill while on an inclined surface (e.g., a hill).

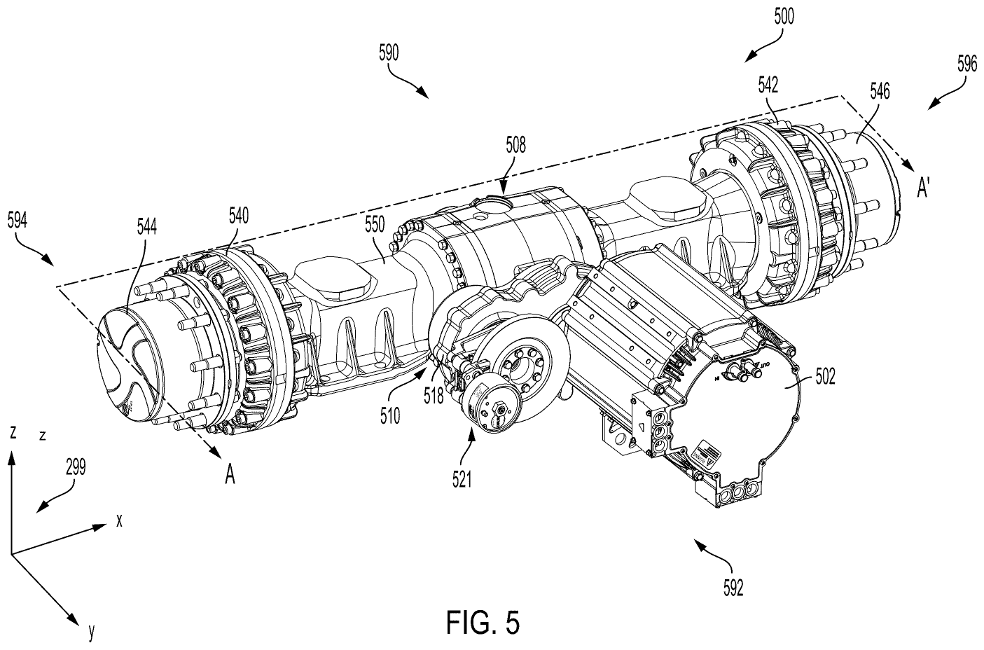

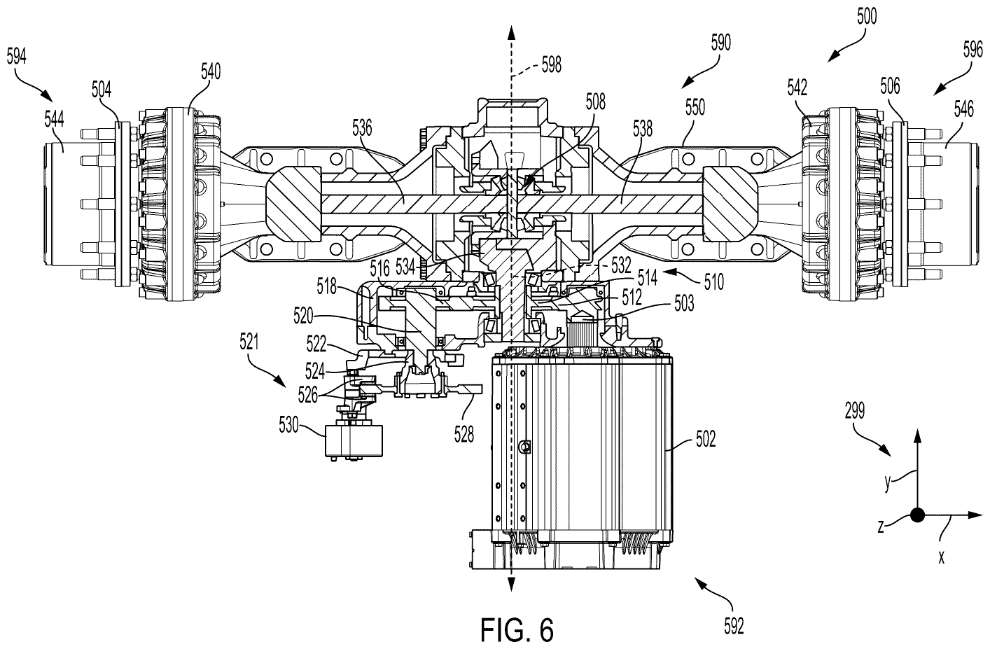

Turning now to FIGS. 5 and 6, an electric drive system 500 according to the present disclosure is shown. The electric drive system 500 may be similar to the electric vehicle drive system 400 described with respect to FIG. 4. The electric drive system 500 is shown in FIG. 5 from an external perspective view and in FIG. 6 in a partially cross-sectional view. FIG. 5 includes a cutting plane A-A′. The cross-section of FIG. 6 is through the cutting plane A-A′. The axis system 299 is again shown in FIGS. 5 and 6 for reference. The electric drive system 500 as herein disclosed may be incorporated into a vehicle system, such as vehicle system 106 of FIG. 1 and/or vehicle system 200 of FIG. 2. The electric drive system 500 as herein described may be configured for front wheel drive, whereby the wheels described are front wheels of the vehicle, though it should be understood that the system as herein described may also be applicable for rear wheel drive vehicle systems.

The electric drive system 500 includes an electric motor 502 coupled to an HSRU 510. It should be understood that the HSRU as herein described is an example of a type of gear set of a transmission system. Other transmission systems including different, more, or less components have been contemplated. In some examples, the transmission system as herein disclosed does not include any planetary gear sets. Using a simple gear set in the transmission system may further reduce complexity, number of needed components, and overall space demands of the electric drive system.

The electric drive system 500 further includes a parking brake assembly 521 also coupled to the HSRU 510. As shown in FIGS. 5 and 6, the parking brake assembly 521 and the electric motor 502 are arranged horizontally adjacent to each other, each coupled to a different gear of the HSRU. For example, the HSRU 510 may be positioned towards a first end 590 (e.g., a first longitudinal end) with respect to the parking brake assembly 521 and the electric motor 502, while the parking brake assembly 521 and the electric motor 502 are both positioned towards a second end 592 (e.g., a second longitudinal end) with respect to the HSRU 510. The parking brake assembly 521 may be positioned towards a first side 594 (e.g., a first side in the horizontal direction) and the electric motor may be positioned towards a second side 596 (e.g., a second side in the horizontal direction), thereby being arranged horizontally adjacent to each other. The first side 594 and the second side 596 may be positioned opposite each other along the horizontal direction. The electric motor 502 may thus be off center from a longitudinal centerline 598 of the electric drive system 500. Positioning the electric motor and the parking brake assembly adjacent to each other may reduce overall footprint of the electric drive system in the longitudinal direction. Further, the number of components, as compared to arranging the parking brake between the transmission and the differential assembly, may be reduced by mounting the parking brake assembly directly to the HSRU housing.

The HSRU 510 may comprise a first gear 512, which may be a motor input pinion gear, a second gear 514, which may be a helical input gear, and a third gear 516, which may be a parking brake gear. The HSRU 510 may be encompassed within an HSRU housing 518, in some examples. An input shaft 503 of the electric motor 502 may be rotationally coupled to the first gear 512 of the HSRU. For example, the input shaft 503 may be a pinion shaft and the first gear 512 may be a matching pinion gear. Via the input shaft 503, rotational power may be transferred from the electric motor 502 into the HSRU 510.

The parking brake assembly 521 may comprise a parking brake disc 528, a parking brake actuator 530, parking brake pads 526, a parking brake flange 524, and a parking brake bracket 522. The parking brake bracket 522 may be mounted to the housing 518 of the HSRU 510. The bracket 522 may be configured to provide structural support and stability to the parking brake assembly 521, thereby maintaining the position of the assembly as mounted on the HSRU housing and reducing any stress or strain on the parking brake shaft 520.

The parking brake pads 526 may comprise a pair of parking brake pads arranged about the parking brake disc 528. The parking brake pads 526 may be configured to engage with the parking brake disc 528 when actuated by the parking brake actuator 530. The parking brake actuator 530 may actuate the parking brake pads 526 to engage the parking brake disc 528 in response to sensor signals. For example, an input by a driver, such as putting the vehicle in park, may transmit a sensor signal indicating that the parking brake is to be applied by engaging the parking brake pads 526 with the parking brake disc 528. In some examples, the parking brake actuator 530 may be actuated by a pneumatic system driven by an electric motor or engine.

The parking brake assembly 521 may be coupled to the HSRU 510 via a parking brake shaft 520. The parking brake shaft 520 may be rotationally coupled to the third gear 516 of the HSRU 510. The parking brake flange 524 may couple the parking brake disc 528 to the parking brake shaft 520. The parking brake shaft 520 may be coupled to the HSRU 510 on the same side of the HSRU 510 as the input shaft 503 of the electric motor 502.

The HSRU 510 is further coupled to a differential assembly 508 configured to transfer rotational power to wheels via drive axles and wheel hubs equipped with planetary gear assemblies. The differential assembly 508 and the drive axles may be positioned within a dedicated housing 550. The HSRU 510 may be coupled to the differential assembly 508 via a pinion assembly. Specifically, the second gear 514 of the HSRU 510 may rotationally couple to a bevel pinion shaft 532, which is fixedly coupled to a bevel pinion gear pair 534. The bevel pinion gear pair 534 may couple to the differential assembly 508. For example, the differential assembly 508 may include a plurality of gears. For example, the differential assembly 508 may comprise multiple pinion gears arranged on the sides and ends. The bevel pinion gear pair 534 may couple to one of the plurality of gears of the differential assembly 508.

As described with respect to FIG. 4, the differential assembly 508 may rotationally couple to a first axle shaft 536 and a second axle shaft 538. The first axle shaft 536 and the second axle shaft 538 may be housed within the housing 550. In some examples, the housing 550 may comprise distinct housings for each of the differential assembly 508, the first axle shaft 536, and the second axle shaft 538 that are formed separately. In other examples, the housing 550 may be formed as a single piece.

The first axle shaft 536 may be arranged on the first side 594 and the second axle shaft 538 may be arranged on the second side 596. Thus, the first and second axle shafts 536, 538 may be arranged opposite each other along the horizontal direction. The first axle shaft 536 may couple to a first planetary gear set and the second axle shaft 538 may couple to a second planetary gear set, which are not fully shown in FIG. 5 or 6. The first planetary gear set includes a first planetary carrier 544 and the second planetary gear set includes a second planetary carrier 546.

A first wheel hub 504 may be engaged with the first planetary gear set such that rotation of the first axle shaft 536 results in rotation of the first wheel hub 504, thereby rotating a first wheel affixed to the first wheel hub 504. Similarly, a second wheel hub 506 may be engaged with the second planetary gear set such that rotation of the second axle shaft 538 results in rotation of the second wheel hub 506, thereby rotating a second wheel affixed to the second wheel hub 506.

A first service brake 540 may be mounted on the housing 550 about the first axle shaft 536. The first service brake 540 may be linked to the first wheel hub 504 via splines and brake friction plates, in some examples. Similarly, a second service brake 542 may be mounted on the housing 550 about the second axle shaft 536. The second service brake 542 may be linked to the second wheel hub 506 via splines and brake friction plates. During operation of the vehicle system in which the electric drive system 500 is incorporated, input to a brake pedal by the driver, may cause the friction plates to engage. Engagement of the friction plates may thus halt rotation of the corresponding wheel hub, bringing the vehicle to a stop.

FIG. 7 shows available configurations of the parking brake assembly 521. In a first configuration 702, shown on the left, the parking brake assembly 521 may be released. In a second configuration 704, shown on the right, the parking brake assembly 521 may be engaged. FIG. 7 schematically shows a portion of the electric drive system 500 of FIGS. 5 and 6 and thus shared components will not be reintroduced, for brevity.

When the parking brake assembly 521 is released, the parking brake pads 526 may not be engaged with the parking brake disc 528. Thus, when the electric motor 502 is providing rotational power to the drive system 500, the gears of the HSRU 510, including the first gear 512, the second gear 514, and the third gear 516, may rotate. In turn, the parking brake shaft 520 and the parking brake disc 528 may freely rotate. Further, rotation may be transferred into the differential assembly 508 and outputted as torque to rotate the wheels via the axle shafts.

When the parking brake assembly 521 is engaged, the parking brake pads 526 may be engaged with the parking brake disc 528. The parking brake assembly 521 may be engaged when the parking brake actuator 530 actuates the parking brake pads 526 to engage the parking brake disc 528. The parking brake actuator 530 may actuate the pads in response to a sensor signal, for example from a parking brake input, which may be triggered by the driver engaging a park status. Engagement of the parking brake pads 526 with the parking brake disc 528, as herein described, may include friction pressure applied on either side of the parking brake disc 528 by the parking brake pads 526. The friction pressure applied to the parking brake disc 528 may halt any rotation of the parking brake disc 528.

Thus, engagement of the parking brake pads 526 with the parking brake disc 528 may halt any rotation of the parking brake disc 528. With the parking brake disc 528 unable to rotate, the parking brake shaft 520, and therefore the third gear 516, and the other gears, of the HSRU 510 may be unable to rotate. Still further downstream, the first and second axles 536, 538 may be unable to rotate and thus the wheels, coupled to the first and second wheel hubs 504, 506, may be unable to rotate. In this way, the vehicle may remain at a standstill even when positioned on an inclined surface.

The technical effect of the electric drive system herein disclosed is that space requirements within an electric vehicle may be reduced. By arranging a parking brake assembly horizontally alongside the electric motor, with both being coupled to the transmission system (e.g., the HSRU) on the same side, the space requirements between the transmission system and the differential assembly to which the transmission system is coupled may be reduced. Further, using a simple transmission system that does not include any planetary gear sets may further reduce the overall space requirements of the system, allowing for greater space efficiency within the vehicle.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric drive system, comprising:
an electric motor;
a gear set rotationally coupled to the electric motor;
a parking brake assembly coupled to the gear set, wherein the parking brake assembly comprises a brake disc and one or more brake pads; and
a differential assembly, wherein the gear set is rotationally coupled to the differential assembly via a pinion gear assembly, wherein the parking brake assembly and the electric motor are arranged alongside each other on the same side of the gear set.

2. The electric drive system of claim 1, further comprising a first axle shaft rotationally coupled to the differential assembly on a first side and a second axle shaft rotationally coupled to the differential assembly on a second side.

3. The electric drive system of claim 2, wherein the first axle shaft also rotationally couples to a first wheel hub via a first planetary gear assembly.

4. The electric drive system of claim 2, wherein the second axle shaft also rotationally couples to a second wheel hub via a second planetary gear assembly.

5. The electric drive system of claim 1, wherein the pinion gear assembly comprises a pinion shaft and a bevel pinion gear pair.

6. The electric drive system of claim 1, wherein the gear set is a high-speed reduction unit (HSRU).

7. The electric drive system of claim 1, wherein the gear set comprises a first gear rotationally coupled to an input shaft of the electric motor, a second gear rotationally coupled to the pinion gear assembly, and a third gear rotationally coupled to the parking brake assembly via a parking brake shaft.

8. The electric drive system of claim 1, wherein the electric motor is offset from a longitudinal centerline of the electric drive system.

9. An electric drive unit for an electric vehicle, comprising:
a parking brake assembly comprising a brake disc and a set of brake pads;
a high-speed reduction gear set (HSRU) comprising a first gear, a second gear, and a third gear; and
an electric motor, wherein the electric motor is rotationally coupled to the first gear of the HSRU on a first end and the parking brake assembly is rotationally coupled to the third gear of the HSRU also on the first end, wherein the electric motor and the parking brake assembly are arranged horizontally adjacent to one another on the first end of the HSRU.

10. The electric drive unit of claim 9, further comprising a differential assembly rotationally coupled to the HSRU via pinion gear on a second end of the HSRU that rotationally couples to the second gear, wherein the second end is opposite the first end along a longitudinal direction.

11. The electric drive unit of claim 10, wherein the differential assembly is rotationally coupled to a first wheel via a first drive axle and a second wheel via a second drive axle.

12. The electric drive unit of claim 11, wherein the first drive axle rotationally couples to a first wheel hub via a first planetary gear set on a first side of the electric drive unit and the second drive axle rotationally couples to a second wheel hub via a second planetary gear set on a second side of the electric drive unit, wherein the first and second sides of the electric drive unit are opposite each other along a horizontal direction.

13. The electric drive unit of claim 9, wherein the electric motor is a traction motor.

14. An electric vehicle system, comprising:
an electric motor comprising an input shaft;
a transmission system coupled to the electric motor via the input shaft at a first longitudinal end of the transmission system;
a parking brake assembly comprising a pair of parking brake pads disposed around a parking brake disc that is rotationally coupled to a parking brake shaft, wherein the parking brake assembly couples to the transmission system via the parking brake shaft at the first longitudinal end of the transmission system;
a differential assembly coupled to the transmission system at a second longitudinal end of the transmission system; and
first and second wheel hubs rotationally coupled to the differential assembly via first and second drive axles, respectively, wherein the electric motor and the parking brake assembly are arranged horizontally alongside each other at the first longitudinal end of the transmission system.

15. The electric vehicle system of claim 14, wherein the transmission system comprises an input speed reduction gear set including a motor input pinion gear, a helical input gear, and a parking brake gear.

16. The electric vehicle system of claim 15, wherein the input shaft of the electric motor rotationally couples to the motor input pinion gear and the parking brake shaft rotationally couples to the parking brake gear.

17. The electric vehicle system of claim 15, wherein the differential assembly couples to the transmission system via a pinion gear assembly comprising a bevel pinion shaft and a bevel pinion gear pair.

18. The electric vehicle system of claim 17, wherein the bevel pinion shaft rotationally couples to the helical input gear and the bevel pinion gear pair rotationally couples to the differential assembly.

19. The electric vehicle system of claim 14, wherein the transmission system does not include any planetary gear sets.

20. The electric vehicle system of claim 14, wherein the first and second wheel hubs respectively rotationally couple to the first and second drive axles via respective planetary gear sets arranged within the first and second wheel hubs.
